(19) United States
(12) Patent Application Publication
(10) Pub. No.: US 2026/0180721 A1
(43) Pub. Date: Jun. 25, 2026

(54) METHODS, APPARATUSES AND SYSTEMS FOR DUAL PHASE HYBRID AUTOMATIC REPEAT REQUEST FEEDBACK

(71) Applicant: InterDigital Patent Holdings, Inc., Wilmington, DE (US)

(72) Inventors: Samuli Turtinen, Ii (FI); Paul Marinier, Brossard (CA); Faris Alfarhan, Montreal (CA); Ghyslain Pelletier, Montreal (CA); Diana Pani, Montreal (CA); Tuong Hoang, Montreal (CA)

(21) Appl. No.: 18/991,075

(22) Filed: Dec. 20, 2024

(51) Int. Cl. H04L 1/1812; H04L 5/00; H04W 74/00

(52) U.S. Cl. CPC H04L 1/1812; H04L 5/0053; H04W 74/002

(57) ABSTRACT

Procedures, methods, apparatuses, systems, devices, and computer program products are provided for dual phase hybrid automatic repeat request (HARQ) feedback. Wireless transmit/receive unit (WTRU) methods and systems include receiving, from a wireless network, first control information and determining that the first control information indicates an initial transmission opportunity in a downlink direction for a HARQ process. The methods and systems further include determining that a previous transport block (TB) associated with the HARQ process was not successfully decoded, and based on the determining, generating and transmitting second control information to the wireless network indicating that the TB was not successfully decoded.

### TECHNICAL FIELD

The present disclosure is generally directed to the fields of communications, software and encoding, including, for example, to methods, apparatuses, and systems related to providing hybrid automatic repeat request (HARQ) feedback.

### BACKGROUND

The user plane interface for telecommunication systems includes a HARQ mechanism for detecting and correcting errors in transmission of data to ensure reliable delivery. However, the HARQ mechanism has rigid network implementation requirements and does not provide flexible handling of data within a single bearer. For example, retransmission associated with the HARQ mechanism requires in-order operation and thus cannot distinguish between high and low priority data. Consequently, the HARQ mechanism may have high overhead and retransmission latency.

### SUMMARY

A wireless transmit/receive unit (WTRU) may be configured to perform a HARQ process. For example, a WTRU may send transport blocks (TBs) to a wireless network in an uplink (UL) direction and/or receive transport blocks from the wireless network in a downlink (DL) direction. However, a WTRU may determine that a previous TB associated with a HARQ process has not been successfully decoded at the WTRU in the DL direction or at the wireless network in the UL direction (e.g., by receiving an indication from the wireless network). In accordance with certain embodiments of this disclosure, the WTRU generates and transmits, to the wireless network, feedback indicating that a previous TB was not successfully decoded (e.g., at the WTRU) in the DL direction. In accordance with certain embodiments of this disclosure, the WTRU transmits at least a portion of a previous TB associated with a HARQ process that was not successfully decoded at the wireless network in the UL direction. Based on the systems and methods of this disclosure, transmission feedback and retransmission performed by the WTRU may be made more efficient with reduced latency and lower protocol overhead. Furthermore, lossless delivery may be ensured, but not required, for proper receiver function.

In accordance with certain embodiments of the present disclosure, methods and systems are provided for using a WTRU to provide dual layer HARQ feedback. In some embodiments, the methods include receiving, from a wireless network, a TB associated with a HARQ process. The methods also include receiving, from the wireless network, first control information. The methods further include determining that the first control information indicates an initial transmission opportunity (e.g., for new data, a non-retransmission opportunity) in the DL direction for the HARQ process. The methods additionally include determining that the TB was not successfully decoded as part of the HARQ process. The methods further include, based on determining that the TB was not successfully decoded, generating second control information indicating that the TB was not successfully decoded and transmitting, to the wireless network, the second control information.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a flow diagram illustrating an example of providing dual phase HARQ feedback in the uplink direction, in accordance with certain embodiments of the present disclosure.

FIG. 3 is a flow diagram illustrating an example of providing dual phase HARQ feedback in the downlink direction, in accordance with certain embodiments of the present disclosure.

FIG. 4 is a flowchart of illustrative steps for providing dual phase HARQ feedback in the downlink direction, in accordance with certain embodiments of the present disclosure; and

FIG. 5 is a flowchart of illustrative steps for providing dual phase HARQ feedback in the uplink direction, in accordance with certain embodiments of the present disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

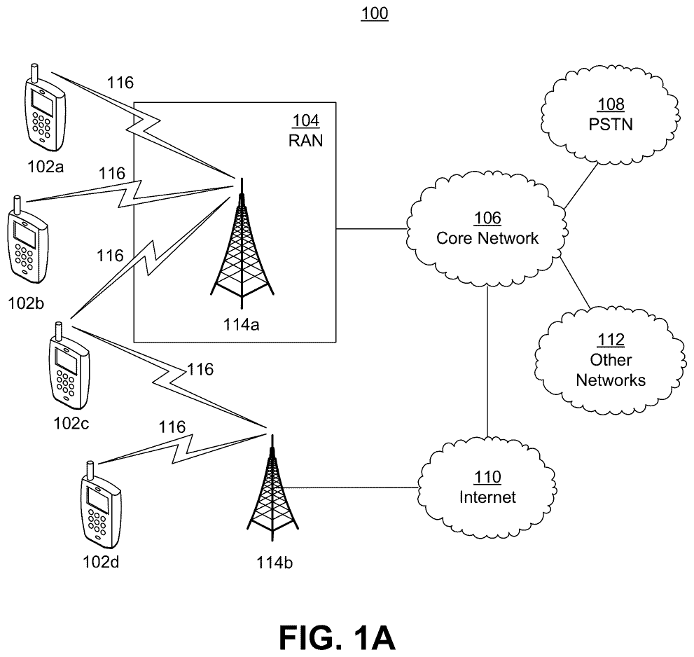

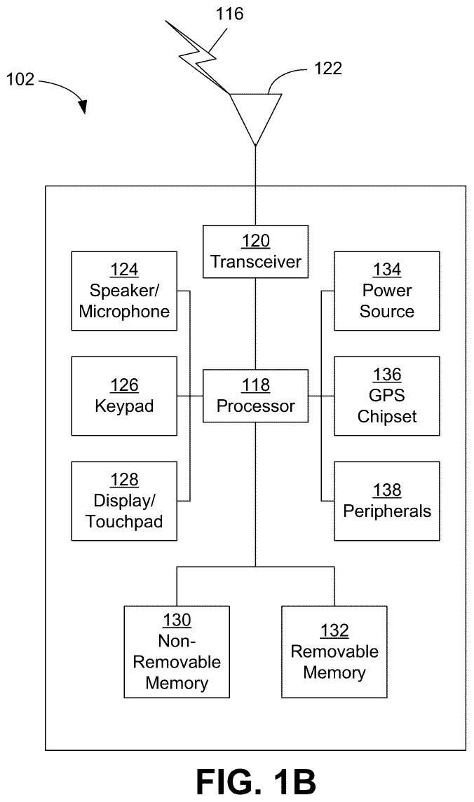

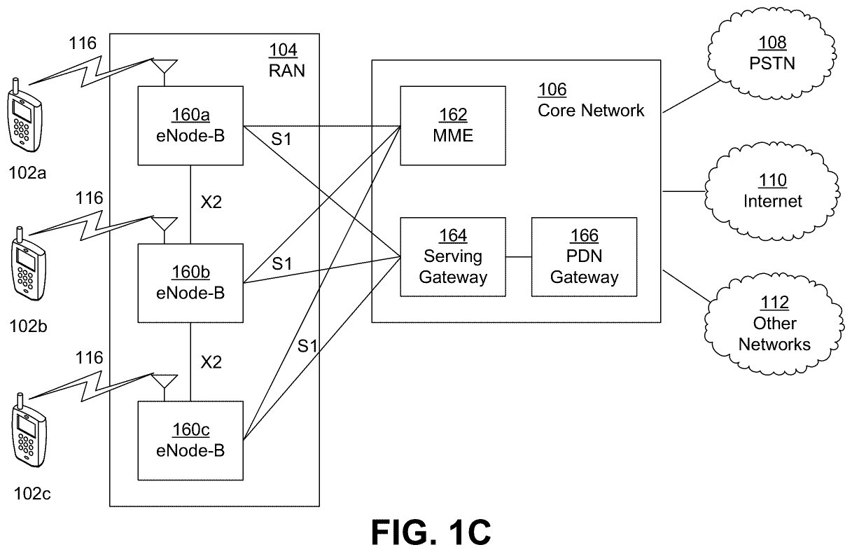

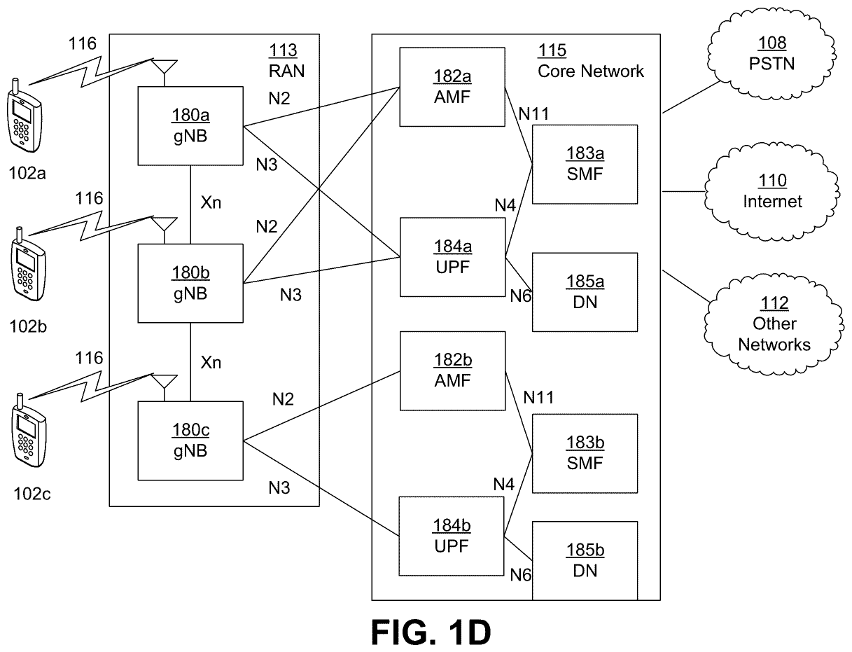

The methods, apparatuses and systems provided herein are well-suited for sensing and communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

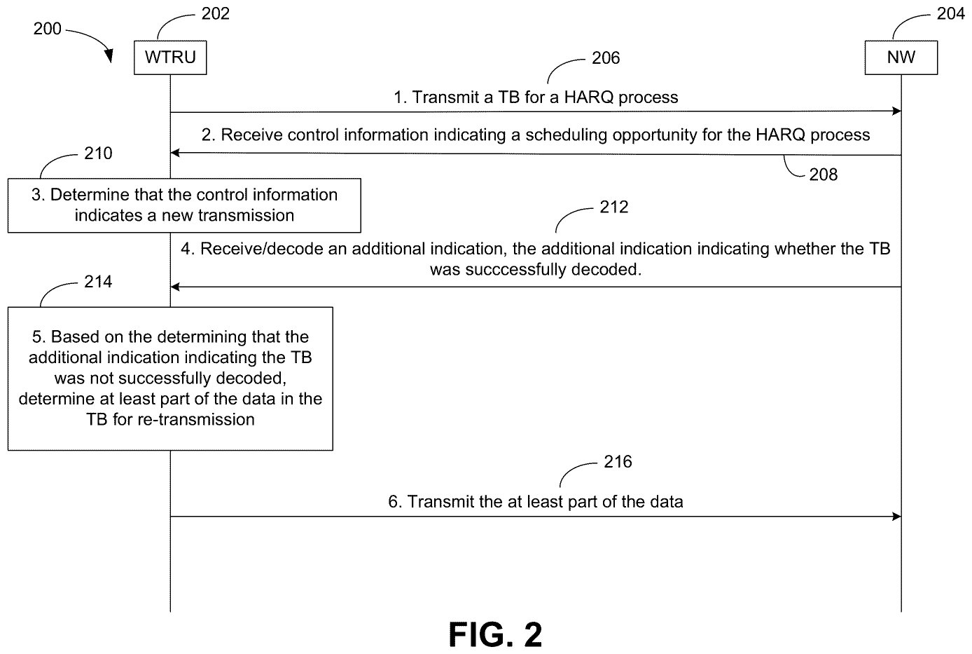

In certain embodiments of the present disclosure, including those described below at least in connection with FIGS. 2-5, the devices, systems, communication links, apparatuses, and other elements depicted in FIGS. 1A-1D may be used in connection with dual phase HARQ feedback.

In some approaches, e.g., for 5G New Radio (NR), transmission feedback and retransmission capabilities are provided by multiple layers for different functions. For example, transmission feedback and retransmission may include at least one of the following: HARQ at the physical (PHY) and/or medium access control (MAC) layers; automatic repeat request (ARQ) at the radio link control (RLC) layer; data recovery at the packet data convergence protocol (PDCP) layer; combinations of the same; or the like.

For example, in connection with dual phase HARQ feedback, HARQ at the PHY and/or MAC layers may provide a fast feedback and re-transmission solution capable of correcting most transmission failures described as follows.

In some approaches, asynchronous incremental redundancy HARQ is supported for downlink (DL) at the PHY layer. For example, the wireless network node (e.g., gNB) provides a WTRU with HARQ acknowledgement (HARQ-ACK) feedback timing, e.g., dynamically in the downlink control information (DCI) or semi-statically in a radio resource control (RRC) configuration. Further, for example, retransmission of HARQ-ACK feedback in the PHY layer may include using an enhanced dynamic codebook and/or one-show triggering of HARQ-ACK transmission for at least one of the following: all component carriers (CCs) and HARQ process in a physical uplink control channel (PUCCH) group; a configured subset of CCs and/or HARQ processes in a PUCCH group; dynamically indicated HARQ-ACK feedback instance; combinations of the same; or the like. Moreover, for example, a HARQ-ACK of a semi-persistent scheduling (SPS) physical downlink shared channel (PDSCH) without associated PDCCH may defer HARQ-ACK feedback to a next available PUCCH transmission occasion based on the HARQ-ACK dropping due to time division duplex (TDD) specific collisions. Further, for example, the WTRU may be configured to receive transmissions based on code block groups and retransmissions may be scheduled to carry only a subset of the total code blocks of a TB.

For example, a for a downlink shared channel (DL-SCH) may be transmitted on a PUCCH. Further, for example, the HARQ-ACK may be transmitted in the form of uplink control information (UCI) on a physical uplink shared channel (PUSCH). Moreover, for example, HARQ-ACK timing may be indicated in DCI, e.g., for scheduling the PDSCH. Additionally, for example, the WTRU builds a HARQ codebook by aggregating HARQ-ACKs indicated for a particular uplink (UL) time.

In some approaches, asynchronous incremental redundancy HARQ is supported for UL at the PHY layer. For example, the network node (e.g., gNB) may schedule each uplink transmission and retransmission using an uplink grant on DCI. Further, for example, the WTRU may be configured to retransmit on configured grants for operations with shared spectrum channel access. Moreover, for example, the WTRU may be configured to receive transmissions based on code block groups and retransmissions may be scheduled to carry only a subset of the total code blocks of a TB. Additionally, for example, up to two HARQ-ACK codebooks corresponding to a priority (e.g., high, low, or the like) may be simultaneously constructed. Furthermore, for example, more than one PUCCH for HARQ-ACK transmission within a slot is supported for each HARQ-ACK codebook. Also, for example, each PUCCH may be limited within one sub-slot, wherein the sub-slot pattern is configured according to the HARQ-ACK codebook.

For example, HARQ-ACK may not be explicitly provided for an uplink shared channel (UL-SCH). Further, for example, the flipping of the new data indicator may be the only indication for whether to build a new transport block (TB) and/or flush the HARQ buffer to make space for new data.

For example, in connection with dual phase HARQ, HARQ is supported at layer 2 (e.g., including MAC layer, RLC layer, PDCP layer, and the like) for error correction services and functions. For example, in the case of carrier aggregation (CA), there may only be one HARQ entity per cell. Further, for example, the HARQ functionality at layer 2 ensures delivery between entities at layer 1. Also, for example, a single HARQ process may support one TB when the physical layer is not configured for DL/UL spatial multiplexing. Additionally, for example, a single HARQ process may support one or more TBs when the PHY layer is configured for DL/UL spatial multiplexing.

In some approaches, ARQ is supported at the RLC sublayer (e.g., of layer 2) for error correction, e.g., only for acknowledgement mode (AM) bearers. For example, ARQ within the RLC sublayer may have at least one of the following characteristics: ARQ retransmits RLC service data units (SDUs) or RLC SDU segments based on RLC status reports; polling for RLC status report is used as needed by RLC; the receiver can also trigger RLC status report after detecting a missing RLC SDU or RLC SDU segment; combinations of the same; or the like. Further for example, ARQ at RLC layer may ensure lossless delivery of data (e.g., for AM radio bearers) and correct any errors that happened in the HARQ process. Additionally, for example, HARQ errors may include at least one of: NACK-ACK misdetection; giving up on a TB due to degraded channel conditions (e.g., which may not be detected until a substantial time has passed and is required for HARQ reordering after HARQ retransmission); combinations of the same; or the like. Also, for example, RLC feedback may be provided from a RLC receiver entity to a RLC transmitted entity (e.g., in the form of status reports). Moreover, for example, RLC feedback (e.g., for AM bearers) may include retransmitting RLC SDUs or segments thereof and data handling information that applies to all data in that radio bearer. Even further, for example, RLC feedback may be a bottleneck for delay sensitive applications due to stalling of the reordering window until reordering timer expiry or the missing protocol data unit (PDU) is received.

In some approaches, data recovery at the PDCP layer is supported, which retransmits data when the RLC layer below is reestablished (e.g., handover, bearer type change, or the like). For example, some previously acknowledged data (e.g., in RLC status reports) is not retransmitted. Further, for example, duplicates may be avoided in the PDCP status report. Also, for example, data recovery may only be performed for AM bearers.

In such approaches, sequence numbering (SN) in multiple layers may be required to perform the retransmissions and feedback, creating overhead. For example, SN schemes may include at least one of: HARQ process ID (PID), RLC SN, PDCP SN, combinations of the same, or the like.

In the present disclosure, HARQ-ACK may be transmitted in at least one of the following: PUCCH, MAC-CE, PUSCH, a 6G equivalent, combinations of the same, or the like.

In the present disclosure, DL signaling may be transmitted in at least one of the following: DCI, MAC-CE, PDSCH, a 6G equivalent, combinations of the same, or the like.

Some approaches to feedback and retransmission are rigidly layered and require a particular implementation of the network (e.g., network architecture). For example, segmentation may need to be done in real time with scheduling decisions, requiring segmentation to be in the same layer as ARQ processes. Consequently, RLC may be required to be placed in the distributed unit (DU) of the network. Further, for example, the radio bearer concept (e.g., of LTE and/or NR) does not allow for flexible handling of high priority data within the same radio bearer. Additionally, for example, high and low priority data may not be distinguished during retransmission due to retransmission windows and ARQ operation at the RLC, which require in-order operation and sequence numbers for proper operation.

Approaches for enhancing the feedback scheme with a more flexible radio user plane design are desired, e.g., for 6G, extended reality (XR), and/or other new applications. For example, desired properties of an enhanced feedback scheme may include at least one of the following: flexibility in layering and network node implementation; fast retransmissions of selected data; improved feedback reliability; low protocol overhead; fast processing; improved support of XR and other applications; a simplified feedback process allowing lossless data delivery (e.g., for services that require lossless data delivery); combinations of the same; or the like. Further, for example, flexibility in layering a network node implementation may include flexible placement of a “retransmission layer” in the network (e.g., in the central unit (CU) or DU).

Accordingly, systems and methods are described as follows that enable a WTRU (e.g., WTRU 102 of FIGS. 1A-D) to send and/or receive HARQ feedback in two phases in connection with a wireless network (e.g., RAN 104 and 113 of FIGS. 1A-D). In some embodiments, the WTRU provides a first phase of feedback as part of a HARQ process (e.g., an acknowledgement (ACK) or a negative acknowledgement (NACK) for a received TB). In some embodiments, the WTRU provides a second phase of feedback (e.g., second level control information) indicating that the TB was not received successfully. In some embodiments, the first phase of feedback and second phase of feedback are sent on the same layer (e.g., the physical layer). In some embodiments, the first phase of feedback and the second phase of feedback are sent on different layers (e.g., the first phase of feedback sent on the physical layer and the second phase of feedback on the RLC layer).

In certain representative embodiments, the WTRU receives control information indicating a transmission opportunity (e.g., an initial transmission opportunity or retransmission opportunity) in an uplink or downlink direction for a HARQ process.

In certain representative embodiments, the WTRU receives control information indicating a transmission opportunity for an uplink direction for a HARQ process described as follows. For example, the WTRU determines whether the control information indicates an initial transmission opportunity (e.g., for new data) or a retransmission opportunity. Further, for example, the WTRU determines that the control information indicates an initial transmission opportunity in the uplink direction for the HARQ process and receives (e.g., and/or decodes) an additional indication (e.g., from the wireless network) indicating whether a previously transmitted TB of the HARQ process was successfully received (e.g., and/or decoded) by the wireless network. Moreover, for example, the WTRU, based on determining that the additional indication was not decoded successfully, determines at least part of the data in the previously transmitted TB that requires retransmission. Additionally, for example, the WTRU considers that at least part of the data for retransmission and transmits the at least part of the data.

In some embodiments, the WTRU maintains a mapping table of SDUs mapped to previously transmitted TBs. In some embodiments, the WTRU may consider the at least part of the data that was mapped to the TB for retransmission, e.g., based on the mapping table.

In certain representative embodiments, the WTRU receives control information indicating a transmission opportunity for a downlink direction for a HARQ process. For example, the WTRU determines whether the control information indicates an initial transmission opportunity (e.g., for new data) or a retransmission opportunity. Further, for example, the WTRU determines that the control information indicates an initial transmission opportunity in the downlink direction for the HARQ process and determines whether a TB previously transmitted for the HARQ process was successfully decoded, e.g., that the TB was not successfully decoded. Moreover, for example, based on determining whether the TB previously transmitted for the HARQ process was successfully decoded, the WTRU encodes second level control information. Also, for example, the WTRU triggers the second level control information transmission and transmits the second level control information (e.g., to the network). Moreover, for example, the second level control information may indicate that the TB previously transmitted for the HARQ process was not successfully decoded.

In some embodiments, the WTRU may determine whether the TB previously transmitted for the HARQ process was successfully decoded prior to receiving the control information indicating the transmission opportunity. In some embodiments, the WTRU may encode second level control information in a MAC-CE or uplink control information (UCI). In some embodiments, the WTRU may encode second level control information including timing information and/or information of at least one of the following: one or more HARQ processes, one or more HARQ entities, on or more carriers, one or more serving cells, one or more bandwidth parts (BWPs), combinations of the same, or the like. In some embodiments, the WTRU may trigger the second level control information based on at least one of the following: determining the TB previously transmitted for the HARQ process was unsuccessfully decoded; determining a timer has expired; polling performed by the wireless network; identifying a (e.g., previous) failure in transmitting second level control information; combinations of the same; or the like. In some embodiments, the WTRU determines whether the transmission is successful, e.g., based on receiving control information associated with the uplink direction of the HARQ process.

Such systems and methods may enable the transmitter (e.g., within the HARQ process) to parse transmitted data and, based on the transmitted data, determine which data needs to be re-transmitted, e.g., by only requiring HARQ process ID level feedback. Additionally, such systems and methods may reduce feedback and retransmission latency as well as reduce protocol overhead, e.g., by reducing requirements for separate status reports. For example, separate status reports (e.g., for each radio bearer) may be avoided by providing feedback for all data within the HARQ process using the HARQ process ID. Furthermore, such systems and methods may support lossless delivery without requiring lossless delivery for proper receiver function (e.g., as is the case in NR RLC AM).

FIG. 2 is a flow diagram 200 illustrating an example of providing dual phase HARQ feedback in the uplink direction, in accordance with certain embodiments of the present disclosure. A method related to flow diagram 200 is described as follows. For example, the WTRU 202 (e.g., WTRU 102 of FIGS. 1A-D) transmits a TB for a HARQ process to the wireless network 204 (e.g., RAN 104 and 113 of FIGS. 1A-D). Further, for example, the WTRU 202 receives 208 control information indicating a transmission opportunity (e.g., scheduling opportunity) for the HARQ process. Moreover, for example, the WTRU 202 determines 210 that the control information indicates an initial transmission opportunity (e.g., for new data) rather than a re-transmission opportunity in the uplink direction for the HARQ process. Additionally, for example, the WTRU 202 receives 212 (e.g., and/or decodes) an additional indication, the additional indication indicating whether the previously transmitted TB of the HARQ process was received (e.g., and/or decoded) successfully by the wireless network 204. Also, for example, the WTRU 202, based on the determining that the additional indication indicating the TB was not successfully decoded, determines 214 at least part of the data in the TB (e.g., TB of transmission 206) for retransmission. Even further, for example, the WTRU 202 considers (e.g., determines) the at least part of the data for re-transmission and transmits 216 the at least part of the data.

In certain representative embodiments, the WTRU 202 receives 208 control information indicating a transmission opportunity (e.g., scheduling opportunity) for the HARQ process. For example, the control information may be provided through DCI over a physical control channel (e.g., PDCCH). Further, for example, control information may identify the HARQ process by including a HARQ process ID or by providing a pre-defined formula. Moreover, for example, the WTRU 202 may be associated with multiple (e.g., two) HARQ processes with the same HARQ process ID, but in different directions (e.g., uplink, downlink). Also, for example, the transmission opportunity may consist of a TB (e.g., and/or size thereof) and a HARQ process ID (PID). Additionally, for example, the HARQ PID may be used by the WTRU 202 to identify a further transmission opportunity for the same HARQ PID and to determine whether to retransmit the previous TB (e.g., stored in the HARQ buffer for that HARQ process) or transmit new data for the HARQ process (e.g., and flush the old TB from the HARQ buffer).

In certain representative embodiments, the WTRU 202 determines 210 that the control information indicates an initial transmission opportunity (e.g., for new data) rather than a retransmission opportunity in the uplink direction for the HARQ process. For example, the initial transmission opportunity may be indicated (e.g., and differentiated from the retransmission opportunity) using a new data indicator (NDI) bit encoded in the control information. Further, for example, if the NDI bit has been toggled since the previous transmission opportunity for the given HARQ process, the control information indicates an initial transmission opportunity. Moreover, for example, if the NDI bit has not been toggled since the previous transmission opportunity for the given HARQ process, the control information indicates a retransmission opportunity.

In certain representative embodiments, the WTRU 202 receives 212 (e.g., and/or decodes) an additional indication, the additional indication indicating whether the previously transmitted TB of the HARQ process (e.g., TB of transmission 206) was received (e.g., and/or decoded) successfully by the wireless network 204. For example, the additional indication may be received in the control information or by other means (e.g., through MAC signaling). Further, for example, the additional indication may consist of a single bit (e.g., indicates success and/or failure). Additionally, for example, the indication may include one or more additional bits corresponding to a small SN or downlink assignment index (DAI) type. Also, for example, based on the one or more additional bits, the WTRU 202 may determine if the additional indication refers to the actual previous TB (e.g., most recent previous TB). In some examples, the WTRU 202 may, based on the one or more additional bits, determine that the control information for the HARQ process (e.g., corresponding to the additional indication) was missed. Even further, for example, the PHY layer of the WTRU may pass the additional indication and the SN information to a HARQ layer (e.g., MAC layer) or a HARQ entity.

In some embodiments, the additional indication, if indicated in the control information, may only be encoded for control information indicating an initial transmission opportunity. In some embodiments, the additional indication, if indicated in the control information may also be encoded for control information indicating a retransmission. In one example, the WTRU 202 is configured to trigger retransmission of the data, e.g., by higher layers (e.g., by RLC layer or PDCP layer), based on the additional indication being provided in control information indicating a retransmission. In such an example, while the HARQ retransmission is performed for the data, the WTRU may trigger a new retransmission in the higher layers as well.

In certain representative embodiments, the WTRU 202, based on the determining that the additional indication indicating the TB was not successfully decoded, determines 214 at least part of the data in the TB (e.g., TB of transmission 206) for retransmission described as follows.

In some embodiments, the WTRU 202 maintains a mapping table of SDUs mapped to previously transmitted TBs. For example, the mapping table may be maintained in accordance with at least one of the following: per HARQ entity, per HARQ process RLC, per PDCP entity, per bearer, per QoS flow, combinations of the same, or the like. Moreover, for example, the mapping table may be maintained on the bit and/or byte level of each SDU. In some examples, the mapping table may be maintained by the MAC entity for all the data. In some examples, each higher layer entity (e.g., RLC or PDCP) may maintain its own mapping table, e.g., for the data handled by the higher layer entity. In some embodiments, the mapping table entries are logged only for data that is configured for retransmissions and/or lossless delivery. In some embodiments, the mapping table entries are logged only for data that requires retransmissions and/or lossless delivery. For example, only higher layer entities (e.g., RLC or PDCP) configured for ARQ and/or retransmissions maintain a mapping table for their handled data.

In some embodiments, the WTRU 202 considers (e.g., determines) the at least part of the data for retransmission that was mapped to the TB, e.g., based on a mapping table. For example, the WTRU 202 may determine the at least part of the data being data that has been mapped to a one or more AM mode RLC entities. Further, for example, the WTRU 202 may determine a second part of the data that has been mapped to one or more unacknowledged (UM) and/or transparent mode (TM) mode RLC entities and based on the determining, does not consider the second part of the data (e.g., for the at least part of the data) for retransmission. Moreover, for example, the WTRU 202 may determine at least part of the data based on data that is configured for (e.g., and/or requires) retransmissions and/or lossless delivery.

In some embodiments, the WTRU 202 may determine the at least part of the data based on quality of service (QoS) attributes associated with the data or SDUs. For example, the QoS attributes may include at least one of the following: priority; packet delay budget (PDB); PDU set delay budget (PSDB); packet error rate (PER); block error rate (BLER); remaining time (e.g., based on discard timer); forward error correction (FEC) ratio; combinations of the same; or the like. For example, the WTRU 202 may identify each SDU or segment of SDU that has been determined to be included in the at least part of the data for retransmission. Further, for example, the WTRU may increment a retransmission counter associated with the SDU, based on the SDU and/or SDU segment identification. Additionally, for example, the WTRU 202 may be configured with types of data (e.g., based on QoS flow, radio bearer, logical channel) to be retransmitted using the dual phase HARQ feedback and types of data to be retransmitted only based on status reports.

In certain representative embodiments, the WTRU 202 considers (e.g., determines) the at least part of the data for re-transmission and transmits 216 the at least part of the data. In some embodiments, the at least part of the data is prioritized over any new data. In some embodiments, any new data with a lower PDB, remaining time, and/or PSDB than the at least part of the data is prioritized over the at least part of the data. For example, such prioritization may only be done if the new data and the at least part of the data do not require mutual sequencing at the receiver. In some embodiments, a retransmission layer (e.g., RLC, PDCP, or the like) retransmits the TB as “new data” at the HARQ or HARQ layer (e.g., MAC layer). In such embodiments, a TB construction layer (e.g., MAC layer) does not require knowledge of whether the SDU is a retransmitted SDU or a new SDU. FIG. 2 is a flow diagram 200 illustrating an example of providing dual phase HARQ feedback in the uplink direction, in accordance with certain embodiments of the present disclosure.

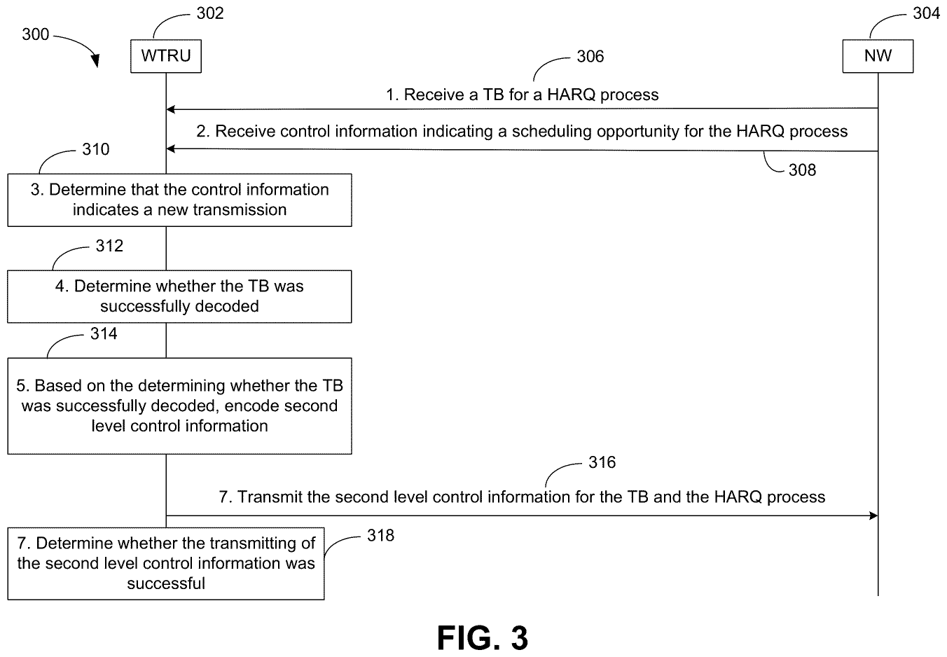

FIG. 3 is a flow diagram 300 illustrating an example of providing dual phase HARQ feedback in the downlink direction, in accordance with certain embodiments of the present disclosure. A method related to flow diagram 300 is described as follows. For example, as shown in FIG. 3, the WTRU 302 (e.g., WTRU 102 of FIGS. 1A-D) receives 306 a TB for a HARQ process from the wireless network 304 (e.g., RAN 104 and 113 of FIGS. 1A-D). Further, for example, the WTRU 302 receives 308 control information indicating a transmission opportunity (e.g., scheduling opportunity) for the HARQ process. Moreover, for example, the WTRU 302 determines 310 that the control information indicates an initial transmission opportunity (e.g., for new data) rather than a re-transmission opportunity in the downlink direction for the HARQ process. Also, for example, the WTRU 302 determines 312 whether the TB (e.g., TB of transmission 306) was successfully decoded. Additionally, for example, the WTRU 302, based on determining whether the TB previously transmitted for the HARQ process was successfully decoded, encodes 314 second level control information. Even further, for example, the WTRU 302 transmits 316 the second level control information (e.g., to the wireless network 304). In addition, for example, the WTRU 302 determines 318 whether the transmission is successful, e.g., based on receiving control information associated with the uplink direction of the HARQ process.

In certain representative embodiments, the WTRU 302 receives 308 control information indicating a transmission opportunity (e.g., scheduling opportunity) for the HARQ process. For example, the control information may be provided through DCI over a physical control channel (e.g., PDCCH). Further, for example, control information may identify the HARQ process by including a HARQ process ID or by providing a pre-defined formula. Moreover, for example, the WTRU 302 may be associated with multiple (e.g., two) HARQ processes with the same HARQ process ID, but in different directions (e.g., uplink, downlink). Also, for example, the transmission opportunity may consist of a TB (e.g., and/or size thereof) and a HARQ process ID (PID). Additionally, for example, the HARQ PID may be used by the WTRU 302 to identify a further transmission opportunity for the same HARQ PID and to determine whether to retransmit the previous TB (e.g., stored in the HARQ buffer for that HARQ process) or transmit new data for the HARQ process (e.g., and flush the old TB from the HARQ buffer).

In certain representative embodiments, the WTRU 302 determines 310 that the control information indicates an initial transmission opportunity (e.g., for new data) rather than a re-transmission opportunity in the downlink direction for the HARQ process. For example, the initial transmission opportunity may be indicated (e.g., and differentiated from the retransmission opportunity) using a new data indicator (NDI) bit encoded in the control information. Further, for example, if the NDI bit has been toggled since the previous transmission opportunity for the given HARQ process, the control information indicates an initial transmission opportunity. Moreover, for example, if the NDI bit has not been toggled since the previous transmission opportunity for the given HARQ process, the control information indicates a retransmission opportunity.

In some embodiments, the WTRU 302 may determine whether a downlink transmission corresponding to the transmission opportunity was successfully decoded and, based on determining whether the downlink transmission was successfully decoded, transmitting first level control information (e.g., to the wireless network 304). For example, the first level control information may include feedback (e.g., ACK or NACK) corresponding to whether the TB was successfully decoded. Further, for example, the first level control information may be transmitted over a physical layer channel (e.g., PUCCH).

In certain representative embodiments, the WTRU 302 determines 312 whether the TB (e.g., TB of transmission 306) was successfully decoded. In some embodiments, the WTRU 302 determines 312 whether the TB was successfully decoded prior to receiving control information indicating the initial transmission opportunity for the HARQ process (e.g., control information of transmission 308).

In certain representative embodiments, the WTRU 302, based on determining whether the TB previously transmitted for the HARQ process was successfully decoded, encodes 314 second level control information. For example, the second level control information may be encoded in a MAC-CE or as UCI (e.g., encoded in PUSCH or PUCCH bits). Further, for example, the second level control information may include at least one of the following: information of one or more HARQ process IDs; a specific HARQ PID; information of one or more TBs for a HARQ process ID; timing information associated with a TB and/or HARQ process transmission; information of a HARQ entity, serving cell and/or BWP associated with a HARQ PID; indication of ACK or NACK; combinations of the same; or the like.

In some embodiments, second level control information related to multiple previous transmissions of a HARQ process may be encoded in the same second level control information for transmission. For example, timing information associated with one or more TB and/or HARQ process transmissions may be provided to differentiate between the TBs for which the second level control information is provided. Further, for example, timing information may be based on at least one of: least significant bits (LSBs) of a system frame number (SFN); time to the last transmission of the TB (e.g., in ms, slots, subframes, or the like); combinations of the same; or the like.

In some embodiments, different HARQ entities with the same HARQ PID may have second level feedback encoded in the same second level control information for transmission.

In some embodiments, the second level control information for a HARQ process may only indicate NACK. For example, ACK may only be indicated for the most recent TB of a HARQ process and the WTRU 302 may encode a NACK for other TBs upon identifying the most recent TB of the HARQ (e.g., and encoding an ACK for the most recent TB of the HARQ).

In certain representative embodiments, the WTRU 302 transmits 316 the second level control information (e.g., to the wireless network 304). For example, the WTRU 302 may trigger transmission of the second level control information based on at least one of the following: identifying an unsuccessfully received TB (e.g., TB of transmission 306) for a HARQ process; identifying that a timer initiated upon identification of an unsuccessfully received TB (e.g., TB of transmission 306) for a HARQ process has expired; polling performed by the wireless network 304; determining a failure in transmitting the second level control information; receiving a specific UL resource (e.g., for PUSCH or PUCCH) to provide the second level control information; determining that UL-SCH resources are available for transmission; combinations of the same; or the like.

For example, the polling performed by the wireless network 304 may be encoded in the control information (e.g., DCI, control information of transmission 308) or provided over a MAC-CE. Further, for example, the polling may be directed to a particular HARQ process or HARQ entity. Moreover, for example, the polling may be a general indication to provide the second level control information for all the HARQ processes or all the HARQ entities of WTRU 302. Also, for example, the polling may indicate that the second level control information should be limited to per cell group.

In some embodiments, the second level control information is multiplexed with other data for an uplink transmission (e.g., over PUSCH).

In some embodiments, the second level control information is transmitted whenever there are UL-SCH resources available for transmission. In some embodiments, when no UL-SCH resources are available for transmission or any available UL-SCH resource is more than a time threshold away in the future, the WTRU 302 triggers a scheduling request (SR). For example, the SR resource may be dedicated to providing network information about the availability of second level control information. Further, for example, the SR resource may be shared among other SR triggers (e.g., buffer status report (BSR)).

In certain representative embodiments, the WTRU 302 determines 318 whether the transmission is successful, e.g., based on receiving control information associated with the uplink direction of the HARQ process. For example, the WTRU 302 may determine the second level control information was not successfully transmitted (e.g., not received by the wireless network 304) and may trigger transmission of second level control information. Further, for example, the second level control information may be transmitted without any modifications. Moreover, for example, the second level control information may be modified (e.g., encoded with further second level control information available at the time of triggering) before triggering transmission.

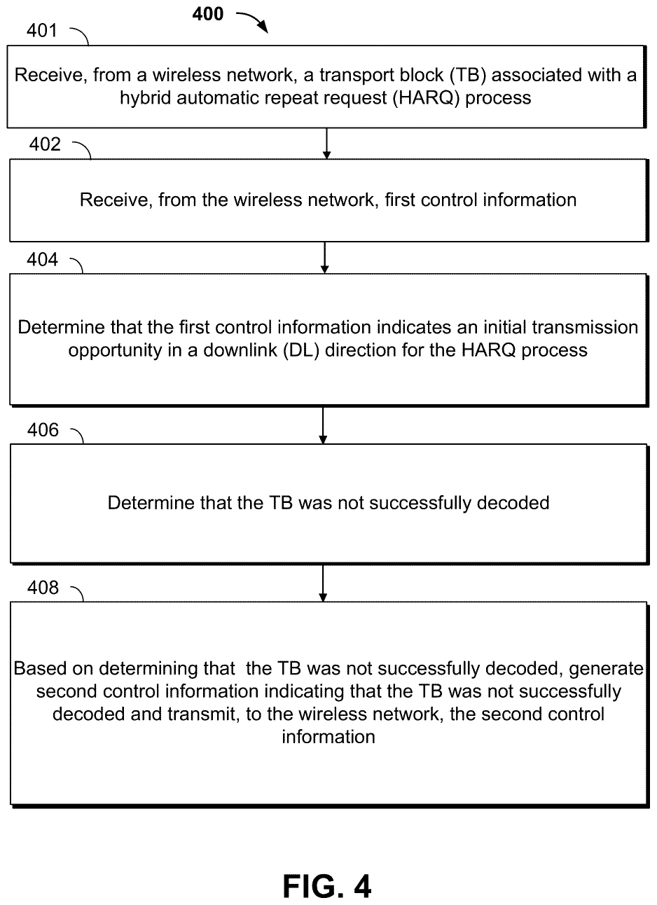

FIG. 4 is a flowchart of illustrative steps for providing dual phase HARQ feedback in the downlink direction, in accordance with certain embodiments of the present disclosure;

In certain representative embodiments, as shown in FIG. 4, a process 400 is performed by a WTRU (e.g., 102 of FIGS. 1A-D, 202 of FIGS. 2, 302 of FIG. 3, or the like) in connection with a wireless network (e.g., RAN 104 and 113 of FIGS. 1A-D, network 204 of FIG. 2, network 304 of FIG. 3), which may be implemented in a communication system such as a communications system 100 illustrated in FIG. 1A-1D. At step 401, the WTRU receives, from a wireless network, a TB associated with a HARQ process. At step 402, the WTRU receives, from the wireless network, first control information. For example, the first control information may include control information indicating a transmission opportunity (e.g., initial transmission opportunity or retransmission opportunity for the HARQ process). Further, for example, the first control information may indicate an uplink direction for the HARQ process (e.g., control information of transmission 208 of FIG. 2) or a downlink direction for the HARQ process (e.g., control information of transmission 308 of FIG. 3). At step 404, the WTRU determines that the first control information (e.g., control information of transmission 308 of FIG. 3) indicates an initial transmission opportunity in a DL direction for the HARQ process. At step 406, the WTRU determines whether the TB (e.g., TB of transmission 306 of FIG. 3) was successfully decoded, e.g., that the TB was not successfully decoded. At step 408, based on determining that the TB was not successfully decoded, the WTRU generates second control information (e.g., in a MAC-CE or UCI) indicating that the TB was not successfully decoded (e.g., encoding 314 second level control information of FIG. 3) and transmits the second control information to the wireless network (e.g., transmitting 316 second level control information of FIG. 3).

In some embodiments, based on receiving the TB, the WTRU transmits a negative acknowledgement as part of the HARQ process to the wireless network prior to receiving the first information. In some embodiments, the second control information comprises at least one of: an ID of the HARQ process; one or more TBs for the HARQ process; information associated with one or more entities, carriers, serving cells, or bandwidth parts of the HARQ process; timing information associated with the HARQ process; an ACK or NACK associated with the HARQ process; combinations of the same; or the like. In some embodiments, the WTRU transmits, to the wireless network, the second control information as part of the HARQ process based on at least one of:
determining that the TB was not successfully decoded; identifying that a timer initiated upon determining that the TB was not successfully decoded has expired; polling of one or more HARQ processes or entities; determining a failure in transmitting the second information; receiving a UL resource; determining that UL-SCH resources are available; combinations of the same; or the like. In some embodiments, the WTRU determines that the first control information indicates the initial transmission opportunity in the DL direction for the HARQ process further includes at least one of:
identifying a HARQ process ID in the first control information; identifying the HARQ process based on a pre-configured formula; combinations of the same; or the like.

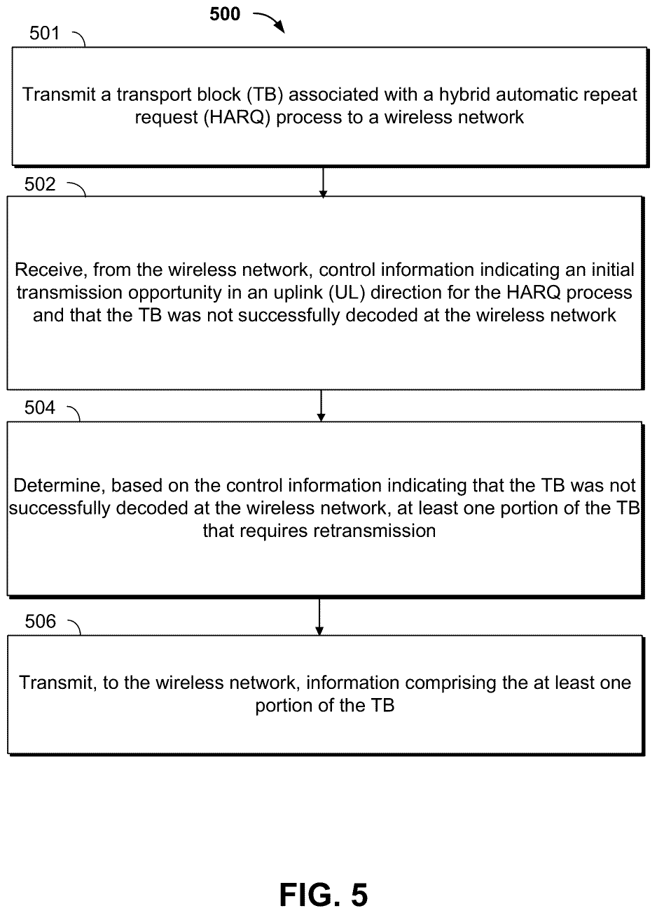

FIG. 5 is a flowchart of illustrative steps for providing dual phase HARQ feedback in the uplink direction, in accordance with certain embodiments of the present disclosure.

In certain representative embodiments, as shown in FIG. 5, a process 500 is performed by a WTRU (e.g., 102 of FIGS. 1A-D, 202 of FIGS. 2, 302 of FIG. 3, or the like) in connection with a wireless network (e.g., RAN 104 and 113 of FIGS. 1A-D, network 204 of FIG. 2, network 304 of FIG. 3), which may be implemented in a communication system such as a communications system 100 illustrated in FIG. 1A-1D. At step 501, the WTRU transmits a TB associated with a HARQ process to the wireless network. At step 502, the WTRU receives, from the wireless network, control information (e.g., control information of transmission 206 and/or indication of transmission 212 of FIG. 2) indicating an initial transmission opportunity in an uplink direction for the HARQ process and that the TB was not successfully decoded at the wireless network (e.g., TB of transmission 206 of FIG. 2). At step 504, the WTRU determines, based on the control information indicating the TB was not successfully decoded at the wireless network (e.g., based on indication of transmission 212 of FIG. 2), at least one portion of the TB that requires retransmission. At step 506, the WTRU transmits, to the wireless network, information including the at least one portion of the TB (e.g., transmitting the at least part of the data 216 of FIG. 2).

In some embodiments, the WTRU determines the at least one portion of the TB that requires retransmission based on a mapping table of SDUs to previously transmitted TBs. In some embodiments, the control information further indicates a higher layer retransmission opportunity and the transmitting the information comprising the at least one portion of the TB uses a first layer. In some embodiments, the WTRU further determines, based on the control information indicating that the TB was not successfully decoded at the wireless network and the higher layer retransmission opportunity, that the TB requires retransmission. In some embodiments, the WTRU retransmits, to the wireless network, the TB using a second layer, wherein the second layer is higher than the first layer. In some embodiments, the WTRU transmits, to the wireless network, the information including the at least one portion of the TB includes prioritizing the at least one portion of the TB over new information. In some embodiments, the WTRU further receives a negative acknowledgement as part of the HARQ process from the wireless network prior to receiving the control information. In some embodiments, the determining the at least one portion of the TB that requires retransmission is based on a SN or DAI in the control information.

In some embodiments, a WTRU (e.g., 102 of FIGS. 1A-D, 202 of FIGS. 2, 302 of FIG. 3, or the like) is configured to perform any combination of the above-referenced steps of the method 400 or the method 500.

In certain representative embodiments, a wireless network (e.g., RAN 104 and 113 of FIGS. 1A-D, network 204 of FIG. 2, network 304 of FIG. 3) communicates with a WTRU (e.g., 102 of FIGS. 1A-D, 202 of FIGS. 2, 302 of FIG. 3, or the like) performing the method 400. For example, the wireless network sends a TB associated with a HARQ process to the WTRU. Also, for example, the wireless network sends first control information (e.g., including control information indicating a transmission opportunity for the HARQ process in a downlink direction) to the WTRU. Further, for example, the wireless network receives second control information (e.g., second level control information) from the WTRU. Moreover, for example, the second control information may indicate whether the TB associated with the HARQ process (e.g., transmitted from the wireless network to the WTRU) had been successfully decoded, e.g., that the TB associated with the HARQ process was not successfully decoded.

In certain representative embodiments, a wireless network (e.g., RAN 104 and 113 of FIGS. 1A-D, network 204 of FIG. 2, network 304 of FIG. 3) communicates with a WTRU (e.g., 102 of FIGS. 1A-D, 202 of FIGS. 2, 302 of FIG. 3, or the like) performing the method 500. For example, the wireless network receives a TB associated with a HARQ process from the WTRU. Also, for example, the wireless network determines whether the TB (e.g., previously transmitted from the WTRU to the wireless network) associated with the HARQ process was successfully decoded, e.g., that the TB associated with the HARQ process was not successfully decoded. Further, for example, the wireless network sends control information (e.g., indicating a transmission opportunity of the HARQ process in an UL direction) to the WTRU. In some embodiments, the control information includes an indication of whether the TB was successfully decoded, e.g., that the TB was not successfully decoded. Moreover, for example, the wireless network receives, from the WTRU, information including an at least one portion of the TB.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), the method comprising:
receiving, from a wireless network, a transport block (TB) associated with a hybrid automatic repeat request (HARQ) process;
receiving, from the wireless network, first control information;
determining that the first control information indicates an initial transmission opportunity in a downlink (DL) direction for the HARQ process;
determining whether the TB was successfully decoded; and
based on determining that the TB was not successfully decoded:
generating second control information indicating that the TB was not successfully decoded, and
transmitting, to the wireless network, the second control information.

2. The method of claim 1, the method further comprising:
based on receiving the TB, transmitting a negative acknowledgement as part of the HARQ process to the wireless network prior to receiving the first control information.

3. The method of claim 1, wherein the second control information comprises at least one of:
an ID of the HARQ process;
one or more TBs for the HARQ process;
information associated with one or more entities, carriers, serving cells, or bandwidth parts of the HARQ process;
timing information associated with the HARQ process; or
an acknowledgement (ACK) or negative acknowledgement (NACK) associated with the HARQ process.

4. The method of claim 1, wherein the transmitting, to the wireless network, the second control information as part of the HARQ process is based on at least one of:
determining that the TB was not successfully decoded;
identifying that a timer initiated upon determining that the TB was not successfully decoded has expired;
polling of one or more HARQ processes or entities;
determining a failure in transmitting the second control information;
receiving a UL resource; or
determining that UL shared channel (UL-SCH) resources are available.

5. The method of claim 1, wherein the determining that the first control information indicates the initial transmission opportunity in the DL direction for the HARQ process further comprises at least one of:
identifying a HARQ process ID in the first control information; or
identifying the HARQ process based on a pre-configured formula.

6. The method of claim 1, wherein the determining that the first control information indicates the initial transmission opportunity in the DL direction for the HARQ process is based on identifying a new data indicator (NDI) bit in the first control information.

7. The method of claim 1, further comprising:
determining that the second control information was not successfully received by the wireless network;
based on determining that the second control information was not successfully received by the wireless network:
update the second control information; and
transmitting, to the wireless network, the updated second control information.

8. A method performed by a wireless transmit/receive unit (WTRU), the method comprising:
transmitting a transport block (TB) associated with a hybrid automatic repeat request (HARQ) process to a wireless network;
receiving, from the wireless network, control information indicating:
an initial transmission opportunity in an uplink (UL) direction for the HARQ process; and
that the TB was not successfully decoded at the wireless network;
determining, based on the control information indicating that the TB was not successfully decoded at the wireless network, at least one portion of the TB that requires retransmission; and
transmitting, to the wireless network, information comprising the at least one portion of the TB.

9. The method of claim 8, wherein the determining the at least one portion of the TB that requires retransmission is based on a mapping table of service data units (SDUs) to previously transmitted TBs.

10. The method of claim 8, wherein the determining the at least one portion of the TB that requires retransmission is based on a sequence number (SN) or a downlink assignment index (DAI) in the control information.

11. The method of claim 8, wherein the control information further indicates a higher layer retransmission opportunity and the transmitting the information comprising the at least one portion of the TB uses a first layer, the method further comprising:
determining, based on the control information indicating that the TB was not successfully decoded at the wireless network and the higher layer retransmission opportunity, that the TB requires retransmission; and
retransmitting, to the wireless network, the TB using a second layer, wherein the second layer is higher than the first layer.

12. The method of claim 8, wherein the transmitting, to the wireless network, the information comprising the at least one portion of the TB comprises prioritizing the at least one portion of the TB over new information.

13. The method of claim 8, further comprising:
receiving a negative acknowledgement as part of the HARQ process from the wireless network prior to receiving the control information.

14. A wireless transmit/receive unit (WTRU) comprising:
a processor; and
a transceiver, wherein the WTRU is configured to:
receive, from a wireless network, a transport block (TB) associated with a hybrid automatic repeat request (HARQ) process;
receive, from the wireless network, first control information;
determine that the first control information indicates an initial transmission opportunity in a downlink (DL) direction for the HARQ process;
determine that the TB was not successfully decoded; and
based on determining that the TB was not successfully decoded:
generate second control information indicating that the TB was not successfully decoded, and
transmit, to the wireless network, the second control information.

15. The WTRU of claim 14, wherein the WTRU is further configured to:
based on receiving the TB, transmit a negative acknowledgement as part of the HARQ process to the wireless network prior to receiving the first control information.

16. The WTRU of claim 14, wherein the second control information comprises at least one of:
an ID of the HARQ process;
one or more TBs for the HARQ process;
information associated with one or more entities, carriers, serving cells, or bandwidth parts of the HARQ process;
timing information associated with the HARQ process; or
an acknowledgement (ACK) or negative acknowledgement (NACK) associated with the HARQ process.

17. The WTRU of claim 14, wherein the WTRU is configured to transmit, to the wireless network, the second control information as part of the HARQ process based on at least one of:
determining that the TB was not successfully decoded;
identifying that a timer initiated upon determining that the TB was not successfully decoded has expired;
polling of one or more HARQ processes or entities;
determining a failure in transmitting the second control information;
receiving a UL resource; or
determining that UL shared channel (UL-SCH) resources are available.

18. The WTRU of claim 14, wherein the WTRU is configured to determine that the first control information indicates the initial transmission opportunity in the DL direction for the HARQ process by at least one of:
identifying a HARQ process ID in the first control information; or
identifying the HARQ process based on a pre-configured formula.

19. The WTRU of claim 14, wherein the WTRU is configured to determine that the first control information indicates the initial transmission opportunity in the DL direction for the HARQ process based on identifying a new data indicator (NDI) bit in the first control information.

20. The WTRU of claim 1, wherein the WTRU is further configured to:
determine that the second control information was not successfully received by the wireless network;
based on determining that the second control information was not successfully received by the wireless network:
update the second control information; and
transmit, to the wireless network, the updated second control information.
